(19) United States
(12) Patent Application Publication
(10) Pub. No.: US 2014/0027545 A1
(43) Pub. Date: Jan. 30, 2014

(54) FUEL INJECTION VALVE

(71) Applicants: Juergen Graner, Sersheim (DE); Martin Maier, Meisenweg 12 (DE); Bernd Rieg, Kawasaki-shi (JP); Volker Sohm, Yongsan-gu (KR); Juergen Lander, Stuttgart (DE); Takuya Mizobe, Ludwigsburg (DE)

(72) Inventors: Juergen Graner, Sersheim (DE); Martin Maier, Meisenweg 12 (DE); Bernd Rieg, Kawasaki-shi (JP); Volker Sohm, Yongsan-gu (KR); Juergen Lander, Stuttgart (DE); Takuya Mizobe, Ludwigsburg (DE)

(21) Appl. No.: 13/822,803

(22) PCT Filed: Jul. 26, 2011
(86) PCT No.: PCT/EP2011/062782

§ 371 Date: Oct. 1, 2013

(30) Foreign Application Priority Data
Sep. 16, 2010 (DE) 10 2010 040 916.2

(51) Int. Cl. F02M 51/06

(52) U.S. Cl. CPC F02M 51/0614
USPC 239/585.1

(57) ABSTRACT

A fuel injection valve for fuel injection systems of internal combustion engines. The valve includes an electromagnetic actuating element having a solenoid, a solid core, an outer magnetic circuit component, and a movable armature for actuating a valve closing element that works together with a valve seat surface provided on a valve seat element. The valve has extremely small outer dimensions. Due to an optimized dimensioning of the electromagnetic circuit, the outer diameter of the outer magnetic circuit component in the circumferential area of the solenoid D_{M}<=11 mm. This increases flexibility in the installation of fuel injection valves having various valve lengths, which are very easily enabled due to the particular modular construction. The valve is suitable as a fuel injection valve, particularly for use in fuel injection systems of mixture-compressing externally ignited internal combustion engines.

### FIELD

The present invention relates to a fuel injection valve.

### BACKGROUND INFORMATION

German Patent No. DE 38 25 134 A1 describes a fuel injection valve that has an electromagnetic actuating element having a solenoid, having an inner pole and having an outer magnetic circuit component and a movable valve closing element that works together with a valve seat allocated to a valve seat element. The injection valve is surrounded by a plastic extrusion coating that extends primarily so as to axially surround the connecting piece, which acts as an inner pole, and the solenoid. At least in the region surrounding the solenoid, ferromagnetic filling materials that conduct magnetic field lines are placed in the plastic coating. In this respect, the filling materials surround the solenoid in the circumferential direction. The filling materials are fine-grained crushed parts of metals having soft magnetic properties. The small metal particles embedded magnetically in the plastic have a more or less globular shape, and are in themselves magnetically insulated and thus do not have any metallic contact with one another, so that no effective magnetic field formation takes place. However, against the positive aspect of a very high electrical resistance that arises here, there is also an extremely high magnetic resistance that is expressed in a significant loss of force, thus resulting in negative functional properties in the overall balance.

In addition, German Patent Application No. DE 103 32 348 A1 describes a fuel injection valve that is distinguished by a relatively compact construction. In this valve, the magnetic circuit is formed by a solenoid, a fixed inner pole, a movable magnetic armature, and an external magnetic circuit component in the shape of a magnet pot. In order to provide a slim and compact construction of the valve, a plurality of thin-walled valve sleeves are used that act both as connectors and as valve seat bearers and as a guide segment for the magnetic armature. The thin-walled non-magnetic sleeve running within the magnetic circuit forms an air gap via which the magnetic field lines go from the external magnetic circuit component to the magnetic armature and inner pole. A fuel injection valve having a comparable design is also shown in FIG. 1, and is explained in more detail below.

Japanese Patent Application No. JP 2002-48031 A describes a fuel injection valve that is also distinguished by a thin-walled sleeve solution, the deep-drawn valve sleeve extending over the entire length of the valve and having in the magnetic circuit area a magnetic separating point in which the otherwise martensitic joint is interrupted. This non-magnetic intermediate segment is situated in such a way, at the level of the area of the working air gap between the magnetic armature and inner pole and in relation to the solenoid, that a magnetic circuit is created that is as effective as possible. Such a magnetic separation is also used to increase the dynamic flow range (DFR) in comparison with conventional valves having conventional electromagnetic circuits. However, such designs are then in turn connected with significant additional manufacturing costs. In addition, the inclusion of such a magnetic separation with a non-magnetic sleeve segment results in a different geometrical design in comparison with valves not having magnetic separation.

### SUMMARY

An example fuel injection valve according to the present invention may have the advantage of a particularly compact construction. The valve has an extremely small outer diameter, which up to now has been considered by specialists in the area of intake pipe injection valves for internal combustion engines to be impossible to manufacture with the highest level of functionality. Due to this very small dimensioning, it is possible to make the installation of the fuel injection valve much more flexible than has been previously possible up to now. Thus, the example fuel injection valves according to the present invention can be installed very compatibly in a wide variety of receptacle bores of various vehicle manufacturers, with numerous “extended tip” variants, i.e., injection valve variants that vary in length, without modifications of the valve needle length or of the valve sleeve length, due to the modular construction of the valve, without having to accept the previously entailed worsened performance with regard to dynamic flow range (DFR) and noise production. The sealing ring seated on the outer magnetic circuit component and that seals against the wall of the receptacle bore on the intake pipe is here easily displaceable.

Advantageously, the new geometry of the fuel injection valve was defined primarily against the boundary conditions regarding the quantities qₘᵢₙ, F_{F}, and F_{Max}. In order to make it possible to realize the extremely small outer dimensions of the magnetic circuit with full functionality, according to an example embodiment of the present invention the outer diameter D_{A} of the armature is defined as 4.0 mm<D_{A}<5.0 mm. The small outer diameter D_{A} of the armature can result in a particularly light valve needle, so that as a consequence during operation of the fuel injection valve significant noise reductions can be achieved compared to the known intake pipe injection valves.

It may be particularly advantageous if with the dimensioning of the fuel injection valve according to the example embodiment of the present invention the dynamic flow range (DFR) can be significantly increased in comparison to the DFR standard in known injection valves.

### BRIEF DESCRIPTION OF THE DRAWINGS

Exemplary embodiments of the present invention are shown in simplified form in the figures and are explained in more detail below.

FIG. 1 shows a valve that can be actuated electromagnetically, in the form of a conventional fuel injection valve.

FIG. 2 shows a first example embodiment of a valve according to the present invention.

FIG. 3 shows a second example embodiment of a valve according to the present invention.

FIG. 4 shows a third example embodiment of a valve according to the present invention, as a particularly suitable “extended tip” version of the fuel injection valve shown in FIG. 3.

### DETAILED DESCRIPTION OF EXAMPLE EMBODIMENTS

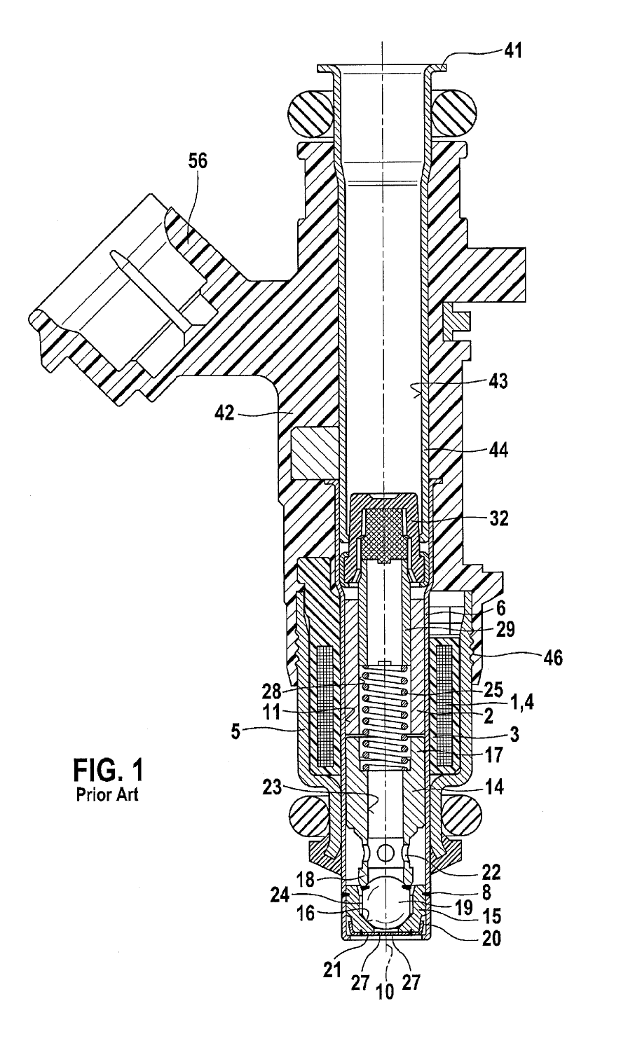

In FIG. 1, for the better understanding of the present invention, as an example a valve is shown that can be actuated electromagnetically, in the form of a fuel injection valve for fuel injection systems of mixture-compressing externally ignited internal combustion engines according to the existing art.

The valve has a largely tubular core 2 surrounded by a solenoid 1, the core acting as inner pole and partly as fuel passageway. Solenoid 1 is completely surrounded circumferentially by an external valve jacket 5 that is sleeve-shaped and stepped, and is for example ferromagnetic, representing an outer magnetic circuit component that acts as an outer pole. Solenoid 1, core 2, and valve jacket 5 together form an actuating element that can be excited electrically.

While solenoid 1 embedded in a coil element 3 externally surrounds a valve sleeve 6 with a winding 4, core 2 is housed in an inner opening 11 of valve sleeve 6 that runs concentrically to a valve longitudinal axis 10. Valve sleeve 6 is elongated and made with thin walls. Opening 11 acts, inter alia, as a guide opening for a valve needle 14 that is capable of axial movement along valve longitudinal axis 10. Valve sleeve 6 extends in the axial direction, e.g., over approximately half the axial overall extension of the fuel injection valve.

In addition, alongside core 2 and valve needle 14, in opening 11 there is also situated a valve seat element 15 that is fastened to valve sleeve 6, e.g., by a weld seam 8. Valve seat element 15 has a fixed valve seat surface 16 as valve seat. Valve needle 14 is formed for example by a tubular armature 17, a likewise tubular needle segment 18, and a ball-shaped valve closing element 19, valve closing element 19 being connected fixedly to needle segment 18, e.g., by a weld seam. At the downstream end face of valve seat element 15, there is situated a, e.g., pot-shaped injection perforated disk 21, whose retaining edge 20, which is bent around and runs around the circumference, is oriented upward opposite the direction of flow. The fixed connection of valve seat element 15 and injection perforated disk 21 is realized for example by a weld seam that is circumferentially tight. One or more transverse openings 22 are provided in needle segment 18 of valve needle 14, so that armature 17 can extend outward in an inner longitudinal bore 23 of fuel flowing through, and can flow along valve closing element 19, e.g., on flattened areas 24, up to valve seat surface 16.

The actuation of the injection valve takes place electromagnetically in a conventional manner. For the axial movement of valve needle 14, and thus for opening against the spring force of a reset spring 25 that engages on valve needle 14, or for the closing of the injection valve, the electromagnetic circuit is used having solenoid 1, inner core 2, outer valve jacket 5, and armature 17. Armature 17 is oriented toward core 2 with its end facing away from valve closing element 19. Instead of core 2, for example a cover part acting as an inner pole that closes the magnetic circuit may also be provided.

Ball-shaped valve closing element 19 works together with valve seat surface 16, which tapers in the direction of flow in the shape of a frustum, of valve seat element 15, said surface being fashioned in valve seat opening 15 downstream, in the axial direction, from a guide opening. Injection perforated disk 21 has at least one, for example four, spray openings 27 formed by erosion, laser drilling, or stamping.

The insertion depth of core 2 in the injection valve is, inter alia, decisive for the stroke of valve needle 14. Here, the one end position of valve needle 14, when solenoid 1 is not excited, is defined by the position of valve closing element 19 on valve seat surface 16 of valve seat element 15, while the other end position of valve needle 14, when solenoid 1 is excited, results from the position of armature 17 on the downstream core end. The setting of the stroke takes place through an axial displacement of core 2 that is subsequently connected fixedly to valve sleeve 6 corresponding to the desired position.

In a flow bore 28 of core 2 that runs concentrically to valve longitudinal axis 10 and that is used to supply the fuel in the direction of the valve seat surface, in addition to reset spring 25 there is fitted a setting element in the form of a setting sleeve 29. Setting sleeve 29 is used to set the spring pre-tension of reset spring 25 situated on setting sleeve 29, which reset spring in turn is supported with its opposite side on valve needle 14 in the area of armature 17, a setting of the dynamic injection quantity also taking place with setting sleeve 29. A fuel filter 32 is situated above setting sleeve 29 in valve sleeve 6.

The inlet end of the valve is formed by a metallic fuel inlet connector 41 that is surrounded by a plastic extruded coating 42 that stabilizes the connector and protects it. A flow bore 43, running concentrically to valve longitudinal axis 10, of a tube 44 of fuel inlet connector 41 acts as fuel inlet. Plastic extrusion coating 42 is for example sprayed on in such a way that the plastic immediately surrounds parts of valve sleeve 6 and of valve jacket 5. A secure seal is here achieved for example via a labyrinth seal 46 on the circumference of valve jacket 5. Plastic extrusion coating 42 also includes an electric plug connector 56 that is also sprayed on.

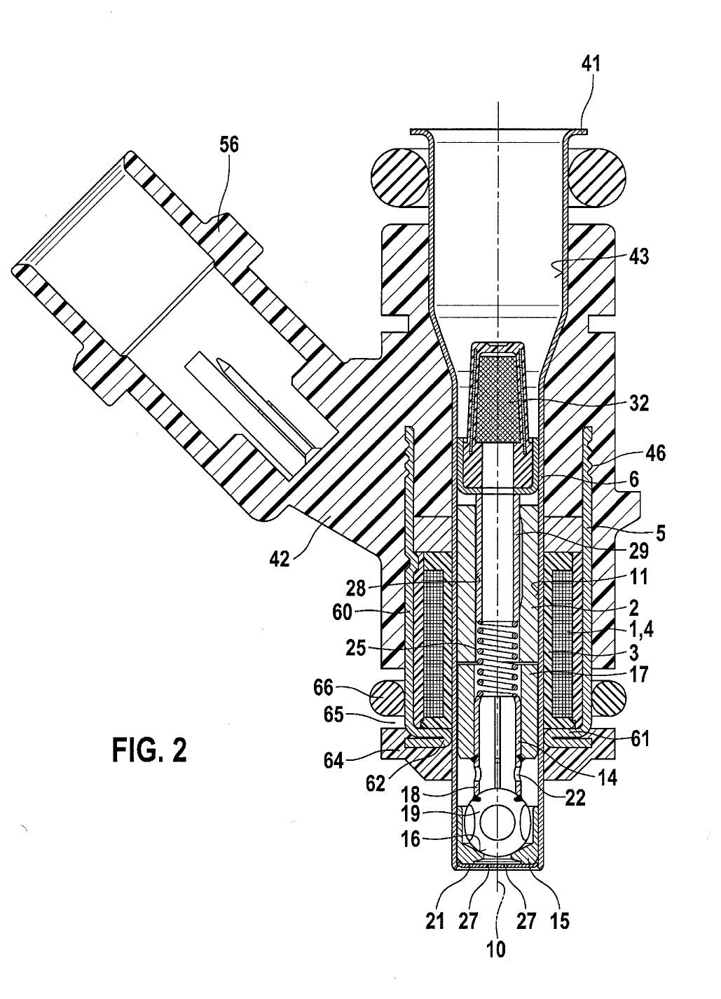

FIG. 2 shows a first exemplary embodiment of a fuel injection valve according to the present invention. The example fuel injection valves according to the present invention are distinguished by a very slim construction, a very small outer diameter, and an overall extremely small geometrical design; due to unequal scale, this is not immediately apparent in FIGS. 1 and 2, or 3. The dimensioning according to the example embodiment of the present invention is explained in more detail below. In the present example, valve sleeve 6 is fashioned running over the entire valve length. Outer magnetic circuit component 5 is fashioned in the shape of a cup, and can also be referred to as a magnet pot. Magnetic circuit component 5 has a jacket segment 60 and a floor segment 61. At the upstream end of jacket segment 60 of external magnetic circuit component 5, there is provided for example a labyrinth seal 46 by which the seal is achieved against plastic extrusion coating 42 that surrounds magnetic circuit component 5. Floor segment 61 of magnetic circuit component 5 is distinguished for example by a fold 62, so that a double layer of wrapped-around magnetic circuit component 5 underneath solenoid 1 is present. A support ring 64 attached on valve sleeve 6 on the one hand holds folded floor segment 61 of magnetic circuit component 5 in a defined position. On the other hand, support ring 64 defines the lower end of an annular groove 65 into which a sealing ring 66 is placed. The upper end of annular groove 65 is defined by a lower edge of plastic extrusion coating 42. Through a suitable dimensioning of the magnetic circuit, outer diameter D_{M} of outer magnetic circuit component 5 in the circumferential area of solenoid 1 is only <=11 mm. Because, in the present embodiment of magnetic circuit component 5, jacket segment 60 runs cylindrically, magnetic circuit component 5 at no point has an outer diameter greater than 11 mm. On the outer circumference of outer magnetic circuit component 5, sealing ring 66 is attached immediately in the area of jacket segment 60, so that the fuel injection valve can still be placed into receptacle bores on the intake pipe having an inner diameter of 14 mm, even with its sealing ring 66 fitted radially outwardly on the magnetic circuit. Sealing ring 66 can be provided in the circumferential area of outer magnetic circuit component 5, at the largest outer diameter thereof.

In order to make it possible to realize an outer diameter of the magnetic circuit that is as small as possible, above all the interior components, such as core 2, acting as inner pole, and armature 17 must correspondingly be made with very small dimensions. In the redimensioning of the magnetic circuit, therefore, 2 mm was defined as the minimum necessary size for the inner diameter of core 2 and armature 17. The inner diameter of the two components core 2 and armature 17 define the inner flow cross-section, and at an inner diameter of 2 mm, the setting of the dynamic injection quantity is still possible using an interior reset spring 25, without it being the case that the tolerance of the inner diameter of reset spring 25 influences the static flow quantity. Various quantities and parameters play a role in the design of the magnetic circuit. Thus, it is optimal to continuously reduce the size of minimum injection quantity qₘᵢₙ to the greatest possible extent. However, here care should be taken that spring force F_{F} is to be kept greater than 3 N in order to guarantee the tightness, standard today and also required in the future, of <1.0 mm³/min. In the present design, a spring force of F_{F}n>3 N, at a sealing diameter of d=2.8 mm, corresponds to the static magnetic force at a voltage Uₘᵢₙ of Fₛₘ>5.5 nN.

For the design of a fuel injection valve having electromagnetic drive, the maximum magnetic force Fₘₐₓ is also a main quantity. If F_{Max} is too small, for example <10 N, this can cause a so-called “closed stuck.” This means that the maximum magnetic force Fmax is too small to overcome the hydraulic adhesive force between valve closing element 19 and valve seat surface 16. In this case, despite the presence of a flow the fuel injection valve would not be able to open.

Therefore, the new geometry of the fuel injection valve was defined above all under the boundary conditions relating to the quantities qₘᵢₙ, F_{F}, and Fₘₐₓ. According to the present invention, in the optimization of the geometry of the magnetic circuit it was found out that outer diameter D_{A} of armature 17 is a main quantity. The optimal outer diameter of armature 17 is 4.0 mm<D_{A}<5.0 mm. The dimensioning of outer magnetic circuit component 5 can be derived from this; an outer diameter D_{M} of magnetic circuit component 5 of a maximum of 11 mm guarantees the full functionality of the magnetic circuit even at a dynamic flow range (DFR) that is significantly higher compared to conventional injection valves. In the embodiment according to FIG. 2, having a continuous thin-walled valve sleeve 6, the optimized dimensioning provides a wall thickness t for valve sleeve 6 at least in the area of the working air gap, i.e., in the lower core area and in the upper armature area, of 0.15<t<0.35 mm.

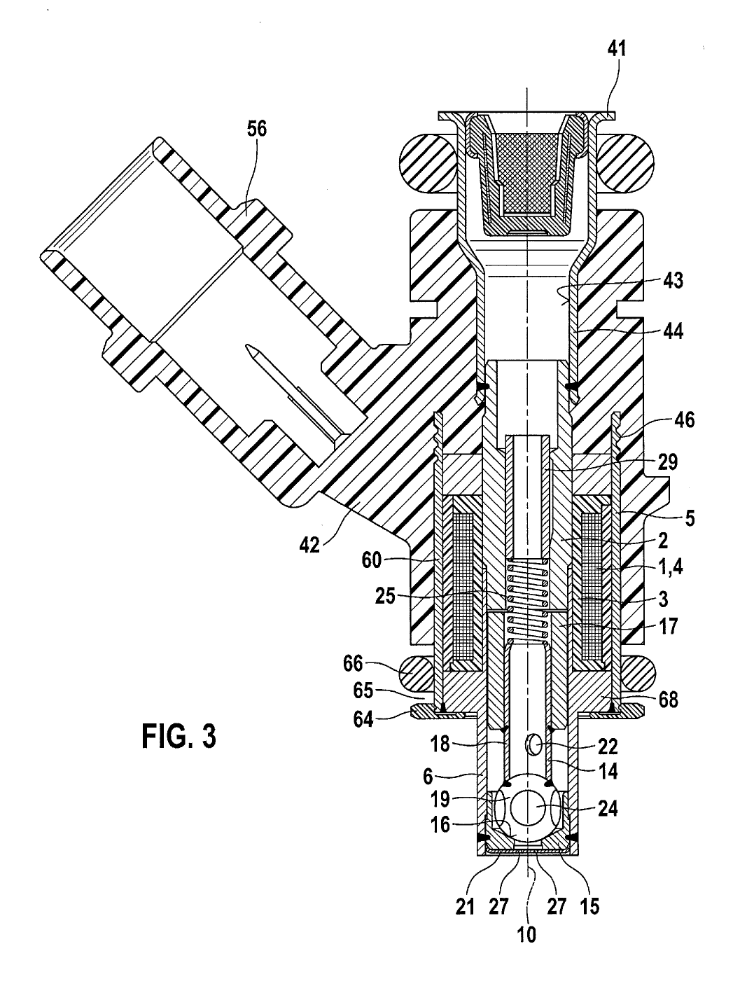

The geometrical and dimensioning considerations presented above also hold in analogous fashion for a fuel injection valve in a different embodiment, as shown in FIG. 3. This fuel injection valve according to FIG. 3 differs generally from that according to FIG. 2 in the area of valve sleeve 6, of core 2, and of outer magnetic circuit component 5. Valve sleeve 6 is here made shorter, and extends from the injection-side end of the valve only into the area of solenoid 1. Upstream from movable valve needle 14 with armature 17, valve sleeve 6 is connected fixedly to tubular core 2. This means that a setting of the stroke via a shifting of core 2 inside valve sleeve 6 is not possible here. At its axially opposite end, core 2 is in turn fastened to a pipe 44 of fuel inlet connector 41 that runs concentrically to valve longitudinal axis 10. In this regard, in this embodiment a continuous thin-walled valve sleeve 6 is not present over the entire valve length. In the construction of outer magnetic circuit component 5, a floor segment was omitted, so that component 5 has a tubular shape. This is possible because valve sleeve 6 has a flange-type collar 68 that stands out radially, on whose outer circumference magnetic circuit component 5 is situated and is fastened thereto for example by a circumferential weld seam. Support ring 64 is fashioned as a flat disk-shaped flange.

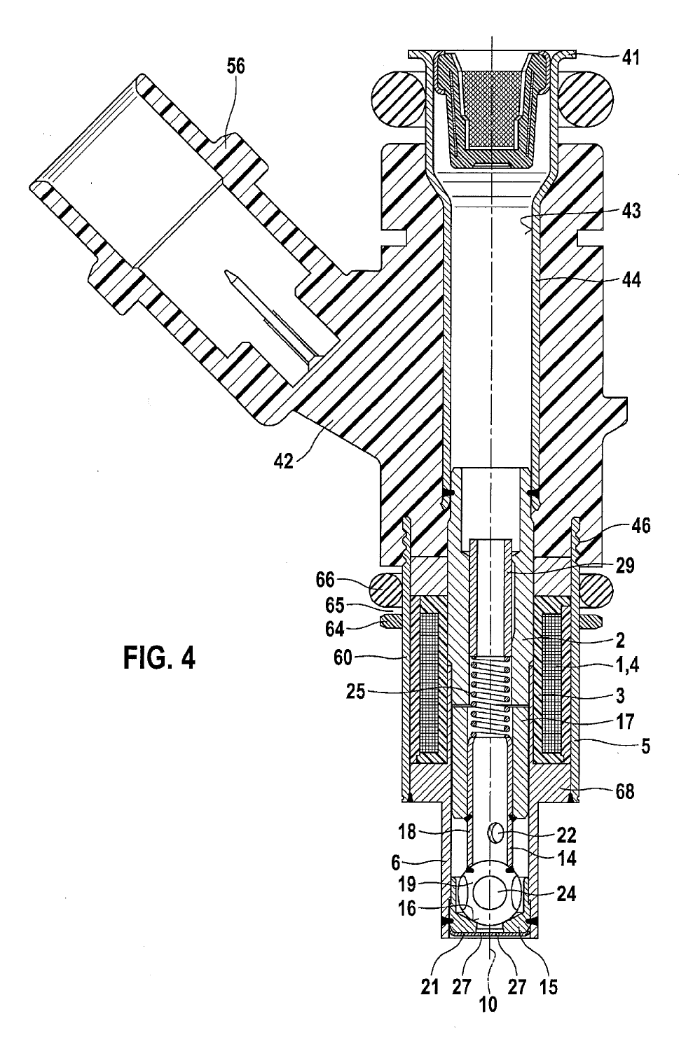

FIG. 4 shows a third embodiment of a valve according to the present invention as a particularly suitable “extended tip” version of the fuel injection valve shown in FIG. 3. On the basis of this Figure, once again the already-mentioned and particularly advantageous possibility of very flexible installation of the fuel injection valve according to the present invention in a receptacle bore on an intake pipe, using standard conventional components (valve needle, armature, valve sleeve), is to be explained. A very large number of vehicle or engine manufacturers form the receptacle bores for the fuel injection valves in the intake pipe injection system in the intake module in a stepped embodiment. Here, the end areas, facing the channel of the intake pipe, of the injection valve receptacle bores standardly have a diameter of approximately 11 mm. These stepped embodiments of the receptacle bores have proven successful for a variety of reasons. On the one hand, in this way a “through-immersion safety device” is provided for the fuel injection valve; i.e., the possibility of the fuel injection valve sliding into the intake pipe is excluded. On the other hand, due to the stepped receptacle bores, tiltings of the fuel injection valves are reduced or avoided. In addition, there is improved flow guidance in the intake pipe for the suctioned air, because the end area of the receptacle bore, having a diameter of only about 11 mm, permits a longer homogenous flow of air in the bore area due to a smaller circulation region. Moreover, for reasons of forming and stability, for the intake module it is necessary that the webs on the intake pipe surrounding the receptacle bores have a minimum size around said bores, which is more likely to be present given a size of the end areas of the receptacle bore of approximately 11 mm.

In order to install fitting fuel injection valves into such stepped fuel injection valve receptacle bores as described above, up to now it has been standard to provide “extended tip” variants of the fuel injection valves. For this purpose, the fuel injection valves have had to be reconstructed by lengthening all the components of the fuel injection valve necessary for the forward positioning of the injection point.

Advantageously, the present invention provides a fuel injection valve that, without lengthening components, nonetheless has a very deep injection point without functional disadvantages, in that the fuel injection valve, together with its entire functional group at the injection side, including the magnetic circuit, can be concealed in a stepped end area of the receptacle bore. As can be seen in FIG. 4, in its axial position sealing ring 66 can be attached variably on magnetic circuit component 5. Because in the present embodiment of magnetic circuit component 5 jacket segment 60 runs cylindrically, magnetic circuit component 5 has at no point an outer diameter greater than 11 mm. In the area of jacket segment 60, sealing ring 66 is attached immediately on the outer circumference of outer magnetic circuit component 5, and the fuel injection valve can still be placed into stepped end areas of the receptacle bores on the intake pipe having an inner diameter of 11 mm, even up to support ring 64 on sealing ring 66.

1-13. (canceled)

14. A fuel injection valve for a fuel injection system of an internal combustion engine, the fuel injection valve having a valve longitudinal axis, and an excitable actuator in the form of an electromagnetic circuit having a solenoid, an inner core, an outer magnetic circuit component, and a movable armature for actuating a valve closing element that works together with a valve seat surface provided on a valve seat element, the outer magnetic circuit component having an outer diameter D_{M} in a circumferential area of the solenoid, wherein D_{M}<=11 mm.

15. The fuel injection valve as recited in claim 14, wherein the outer magnetic circuit component runs cylindrically with a jacket segment, and has at no point an outer diameter greater than 11 mm.

16. The fuel injection valve as recited in claim 14, wherein a sealing ring is attached immediately on the outer circumference of the outer magnetic circuit component.

17. The fuel injection valve as recited in claim 16, wherein in a circumferential area of the outer magnetic circuit component, the sealing ring is on a largest outer diameter thereof

18. The fuel injection valve as recited in claim 16, wherein the fuel injection valve, with the sealing ring fitted radially externally on the magnetic circuit, is configured to be brought one of: i) into receptacle bores on an intake pipe having an inner diameter of 14 mm, or ii) into end areas of the receptacle bores having an inner diameter of 11 mm.

19. The fuel injection valve as recited in claim 14, wherein the armature has an diameter DA, wherein 4.0 mm<DA<5.0 mm.

20. The fuel injection valve as recited in claim 14, further comprising:
a thin-walled valve sleeve that extends at least partly in an area of the electromagnetic circuit.

21. The fuel injection valve as recited in claim 20, wherein the valve sleeve has a wall thickness t at least in an area of a working air gap in a lower core area and in an upper armature area, wherein 0.15<t<0.3 5 mm.

22. The fuel injection valve as recited in claim 20, wherein the thin-walled valve sleeve extends over an entire axial length of the fuel injection valve.

23. The fuel injection valve as recited in claim 14, wherein the outer magnetic circuit component has a cup shape, having a jacket segment and a floor segment.

24. The fuel injection valve as recited in claim 23, wherein the floor has a double layer due to a fold.

25. The fuel injection valve as recited in claim 24, wherein the inner core is connected to a downstream end to the valve sleeve.

26. The fuel injection valve as recited in claim 25, wherein the valve sleeve has a flange-type collar that stands outward radially, on whose outer circumference the outer magnetic circuit component is situated and is fastened thereto.
